(19) United States
(12) Patent Application Publication
(10) Pub. No.: US 2011/0239832 A1
(43) Pub. Date: Oct. 6, 2011

(54) ADJUSTABLE WRENCHES

(75) Inventors: Yosef Arbel, Tel-Aviv (IL); Gad Tavori, Arad (IL)

(73) Assignee: Manganon Special Products Development Ltd., Tel-Aviv (IL)

(21) Appl. No.: 13/133,152

(22) PCT Filed: Dec. 7, 2009
(86) PCT No.: PCT/IL2009/001153

§ 371 Date: Jun. 7, 2011

(30) Foreign Application Priority Data
Dec. 8, 2008 (IL) 195779

(51) Int. Cl. B25B 13/20

(52) U.S. Cl. 81/129

(57) ABSTRACT

This is an invention that permits the construction of tools that are especially efficient, convenient, and economical. The tools in this invention are adjustable wrenches, a ring wrench, an open end wrench and a pipe wrench, intended for loosening and tightening bolts having heads of various sizes, while they accurately grip the head of the bolt. Ther wrench is adjusted to the bolt immediately in a continuous movmement. We refer to closed and open endede wrenched for suitable bolts, in metric of inch sizes, or a combination of these, as well as a pipe wrench. The current invention offers a wrench that requires only one hand to be used for loosening and tighetning any bolt, smoothly and preciesely, and without damanging the bolt itself. Adjustment to the size of the head of the bolt is done in a smooth and continuous movement, at the end of which the wrench is locked precisely on the size of the bolt.

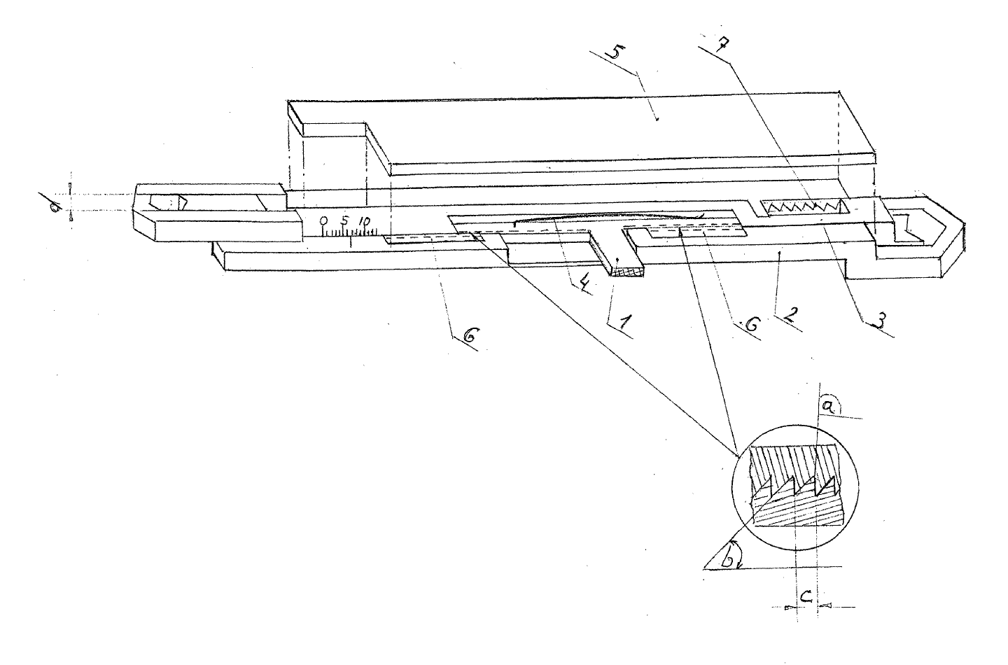

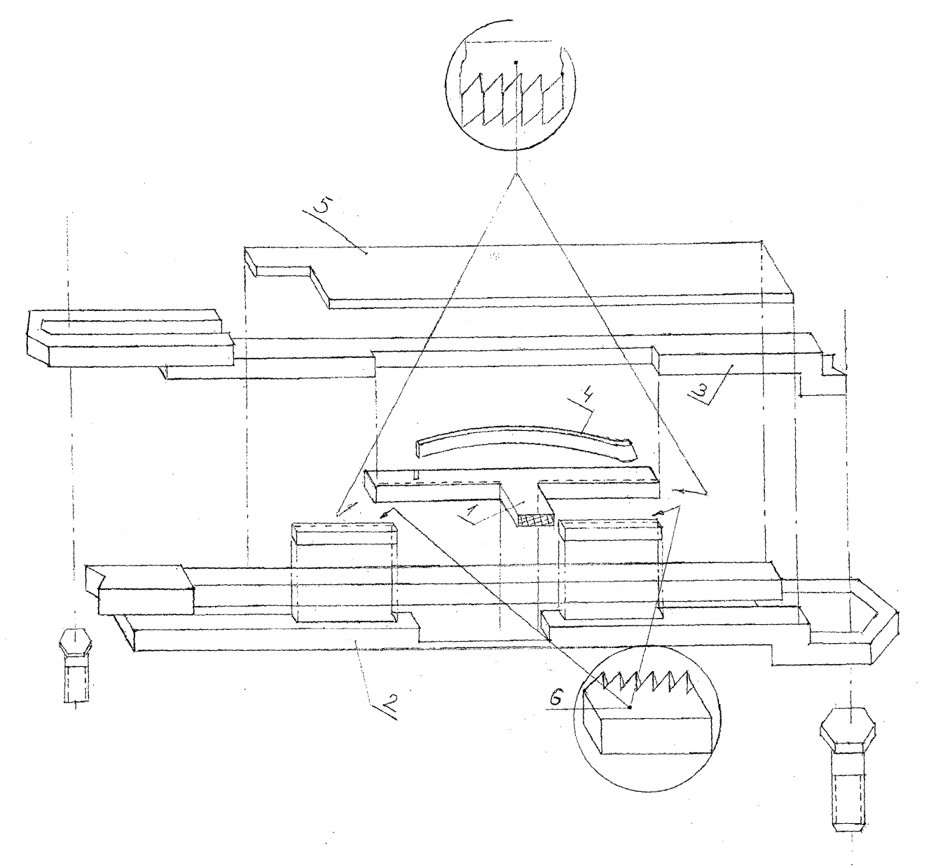

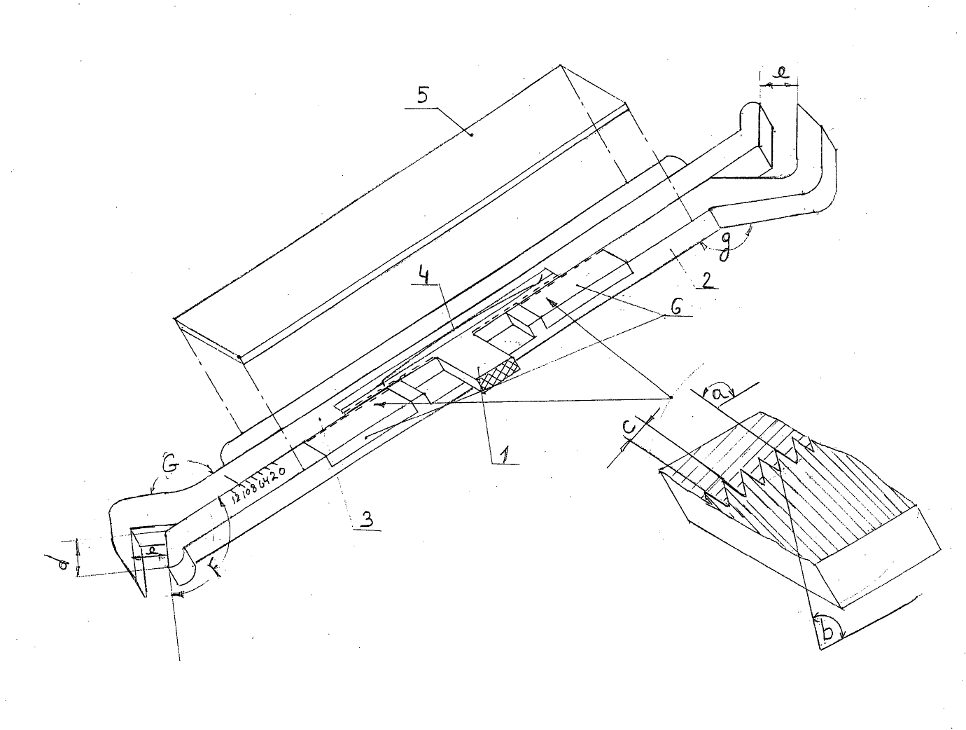

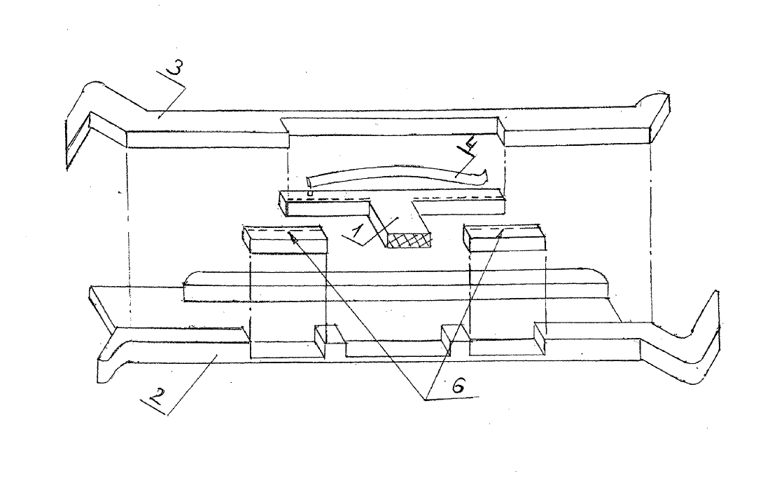

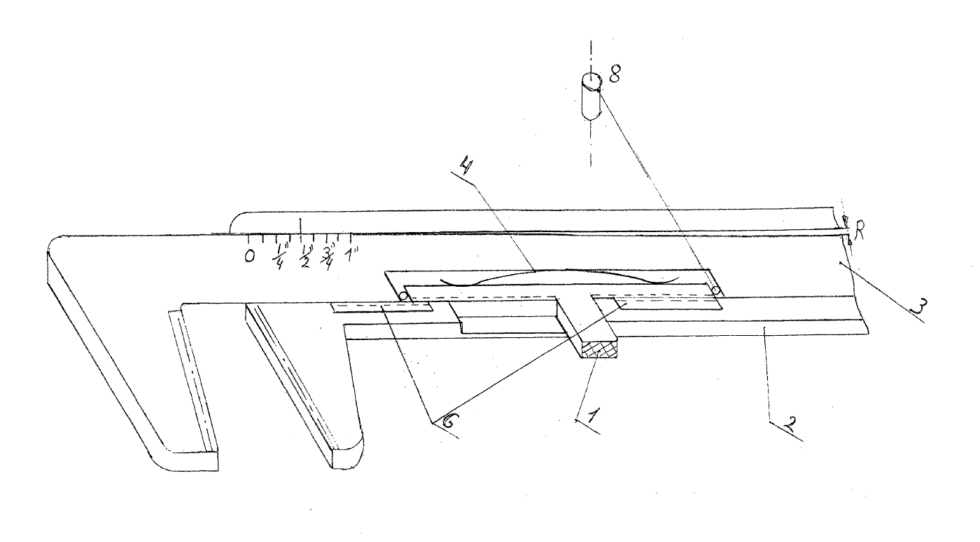

This is an invention that permits the construction of tools that are especially efficient, convenient, and economical.

The tools in this invention are adjustable wrenches, a ring wrench, an open end wrench and a pipe wrench, intended for loosening and tightening bolts having heads of various sizes, while they accurately grip the head of the bolt. The wrench is adjusted to the bolt immediately in a continuous movement.

We refer to closed and open ended wrenches for suitable bolts, in metric or inch sizes, or a combination of these, as well as a pipe wrench.

A number of tools exist for which patents have been registered, and that are intended for the same purpose. None of them is identical or similar to the tools referred to above.

The closest tool is a wrench for opening bolts, for which US Pat. No. 6,305,249 B1 has been registered (hereinafter. “the previous invention”). Several other patents in the field of the aforesaid tools, that are totally different from the tool referred to above, appear below.

U.S. Pat. No. 3,636,800

U.S. Pat. No. 2,437,801

U.S. Pat. No. 6,257,100

GB 688328

U.S. Pat. No. 4,967,613

U.S. Pat. No. 6,076,434

U.S. Pat. No. 3,36,490

Those patents do not meet the following requirements that make the wrench efficient and convenient. They require the use of both hands, the tool does not grip the bolt precisely, firmly, and rigidly, and is awkward to use.

The wrenches forming the subject of the current invention have a unique mechanism permitting convenient uses that do not exist in other patents. For example, they require the use of one hand only for all kinds of activities, they grip the head of the bolt totally accurately and rigidly, whether metric or inch bolts are used.

The current invention offers a wrench that requires only one hand to be used for loosening and tightening any bolt, smoothly and precisely, and without damaging the bolt itself. Adjustment to the size of the head of the bolt is done in a smooth and continuous movement, at the end of which the wrench is locked precisely on the size of the bolt.

The fact that the wrench acts on both its sides permits adjustment to a very large range of sizes of bolts.

The method of the teeth in the tool permits adjustment to bolts in metric sizes, or alternatively, to inch sizes.

### DESCRIPTION OF THE INVENTION AND ITS PARTS

The invention is an adjustable wrench. This wrench permits its user to select the size of the head of the wrench in accordance with the size of the head of the bolt (or the nut).

The wrench comprises three major parts that slide over one another.

Part No. 2 is a fixed part, part No. 3 is a moving part, and part No. 1 is the catch attached to part No. 3.

The user grips part No. 2—the fixed part, and moves part No. 3, the moving part, by means of catch No. 1, in order to open or close the wrench.

Part No. 1 is the catch pressed by a spring (part No. 4) against two parts (No. 6) permanently attached to part No. 2.

When no pressure is applied to the catch (part No. 1), the teeth of the catch and the teeth of parts No. 6 intermesh and part No. 3 is unable to move to a different size.

When the catch (part No. 1) is pressed against the spring (part No. 4), part No. 3 is free to move to the desired size.

The angle of the tooth “a” in drawing No. 3 will be 90° (measured relative to the longitudinal axis of the wrench) or close to 90°, so that when using the wrench (when applying force between parts 2 and 3 in order to increase the size of the head of the wrench) there will be no movement between parts 2 and 3.

The angle of the tooth “b”, that is less than 90° as described, ensures that if a force is applied to the catch (part No. 1) in the direction of the axis of the wrench in order to close the head of the wrench, the teeth will slide and moving part No. 3 will move. The result permits reducing the size of the head of the wrench without the need to press the catch (part No. 1) against the spring (part No. 4), thus permitting convenient use of the wrench. “C” is the pitch of the tooth.

This dimension is determined as follows: Measure the movement “H” of part No. 3 relative to part No. 2, when we move the size of the head of the wrench from a specific value to the next size.

“C” may receive different values, as follows:

H=n.C

n is a natural number (1,2,3 . . . )

After we determine the dimension “C” using the above described method, we can determine the size of the head of the wrench precisely based on the size of the head of the bolt (or nut). The catch, the spring of the catch, and the movement of the catch are located inside a groove existing in the moving part (part No. 3), in a different way from the previous invention, where the catch, the spring and the movement of the catch are connected to the fixed part. This permits:
To grip the fixed part (No. 2) during use and easily move part No. 3 with one hand.
To locate using the same wrench, on the side opposite the existing head of the wrench, an additional head without adding parts. This permits using a head of a wrench, that is of the right size relative to the bolt or the nut.
The advantage of the this mechanism over the previous invention is that the forces between parts 2 and 3 are transferred to rigid parts (teeth and part No. 3), in contrast to the previous invention, in which the forces pass against non-rigid parts (springs).
In the previous invention most of the force is applied to the pin in a shearing motion.

With Reference to the Open Ended Wrench (Drawing No. 3)

In the open ended wrench the head of the wrench is of a special shape.
The angle “g” indicates this unique feature. This, shape permits the head of the bolt or the nut to be located near the axis of symmetry of the wrench and consequently facilitates convenience in work. In addition, the forces acting on the edges of the wrench are smaller.
The angle “F” changes the form of movement of part No. 3 against part No. 2, from horizontal to vertical motion, when applying force to loosen or tighten the bolt.

With Reference to the Pipe Wrench (Drawing No. 5)

Parts No. 8 in drawing No. 5 are two rollers whose purpose is to prevent locking between the catch, part No. 1, and part No. 3. The sides of part No. 2 inside which part No. 3 moves are inclined so that on the broad end of the wrench (the handle) there is a gap indicated by the letter “R”. The letter “P” indicates the gap between part No. 2 and part No. 3, that is a minimum gap, in order to permit rotary movement of part No. 3 relative to part No. 2.

### THE DIFFERENCES BETWEEN THE INVENTIONS

As stated above, the closest patent is U.S. Pat. No. 6,305,249 (hereinafter: “the previous invention”). The following are the differences between the two inventions, the advantages of the current invention and the drawbacks of the previous invention.

The Difference in the Teeth Locking the Tool on the Bolt

In the previous invention there is no reference to the shape of the teeth. The drawing indicates standard teeth with no unique features.

In the current invention the teeth are of a special shape permitting, on the one hand, the wrench to be closed to the size of the bolt in a continuous movement, and on the other hand, in the opposite direction the wrench is set and locked.

In the previous invention there is no reference to the distance between the teeth. Consequently the locking on the bolt is not precise, according to the size of the bolt, but is only approximate.

In the current invention the teeth are located at a measured distance apart, so that the gap matches the difference of the dimensions of the bolts in accordance with the formula H=N.C, and the result is precise gripping of the bolt.

The Difference in the Teeth Catch

In the previous invention the catch is located in the fixed part of the wrench.

In the current invention the catch is located in the moving part of the wrench. This permits use to be made of the other side of the tool also, using one hand only.

In the previous invention only one side of the tool is active.

In the current invention both sides are active.

This permits twice as many sizes as in the previous invention. This permits the size of the head of the wrench to be proportional to the head of the bolt.

In the previous invention the spring holding the teeth arm absorbs a load from part No. 3 that is moving backwards, because of the shape of the teeth.

In the current invention the teeth and part No. 3 bear this load, thus fixing and locking the size of the wrench.

In the previous invention the shape of the teeth allows the size of the head of the wrench gripping the bolt to change when using the wrench.

In the current invention the teeth are locked and do not permit movement of the parts of the wrench when force is being applied. This permits greater force to be applied without causing wear to the head of the bolt.

In the previous invention the arm of the teeth moves in a circle, thus not permitting teeth of 90°.

In the current invention the teeth move in a line perpendicular to the longitudinal axis of the wrench. This permits more teeth, meaning greater strength, and also permits constructing teeth with an angle of 90°, with all the advantages entailed therein.

In the previous invention the load during tightening or loosening of the bolt is directed at the pin, and the holes holding the arm of the teeth, in a shearing motion, that considerably affects the life of the tool.

In the current invention all the load is applied to the teeth only. This prevents wear of the parts of the wrench and ensures greater strength and a longer life for the wrench.

The Difference in Structure

In the previous invention the catch is attached to the fixed part.

In the current invention the catch is attached to part No. 3.

This difference means that in the previous invention both hands are needed to cause the tool to grip the head of the bolt in a size near its size.

In the current invention only one hand is needed to adjust the wrench to the head of the bolt and its precise size.

1-12. (canceled)

13. A wrench comprising
a) a catch (1),
b) a fixed part (2),
c) a moving part (3),
d) whereby the fixed part (2) serves as a guide for the moving part (3) that is movable inside the fixed part (2) and
e) the catch (1) is located in the moving part (3) and selectively fixes the moving part (3) to the fixed part (2).

14. A wrench according to claim 13, wherein two teethed parts (6) are attached to the fixed part(2), whereby the fixed part (2) serves as a gripping handle with a jaws of the wrench at its end.

15. A wrench according claim 14, wherein the end of the moving part (3) constitutes a moving jaw located opposite the fixed jaw of the fixed part (2) and
the catch (1) is attached to the moving part (3) by means of a pair of pins (8), by guide means or groove means and
the catch (1) has teeth and a part of it protrudes from the fixed part (2) in such a way that by pressing on it with a finger, the teeth can be moved in a direction perpendicular to the longitudinal axis of the wrench, and the catch is movable in the longitudinal direction of the wrench for closing or opening of the jaws.

16. A wrench according to claim 15, wherein a spring pushes the catch from inside the movable part perpendicular to the longitudinal axis of the wrench, in the direction of the two parts (6) causing intermeshing of the teeth of the catch with teeth of the two parts (6).

17. A wrench according to claim 16, wherein the two parts (6) are permanently attached to the fixed part (2) and when the teeth of the catch mesh with the teeth of the two parts (6) movement of the movable part (3) is prevented or alternatively when the catch is pressed the teeth are released and the movable part (3) is free to move.

18. A wrench according to claim 13, wherein the wrench is a pipe wrench and
the fixed part (2) constitutes an inclined guide, whereby the narrow side is located near the jaws of the wrench and serves as a guide for the movable part (3) that moves inside it,
the moving jaw is perpendicular to the longitudinal axis of the wrench and
the gap between the movable part (3) and the fixed part (2) in its smallest place is minimal, so that the movable part is freely movable in the longitudinal direction of the wrench and
on the broad side of the guide is a gap permitting the movable part (3) to move perpendicular to the longitudinal axis of the wrench

19. A wrench according to claim 18, wherein the rollers are located in a groove of the moving part (3) , wherein the catch (1) is located between them.

20. A wrench according to claim 15, wherein one side face of each tooth of the catch (1) and the two parts (6) forming an angle of substantially 90 degrees.

21. A wrench according to claim 19, wherein the other side face of each tooth of the catch (1) and the two parts (6) forming an angle of less than 90 degrees.

22. A wrench according to claim 13, wherein the wrench is an open ended wrench or a ring wrench, and wherein the wrench comprises two catches, a first catch adapted for metric sizes and a second catch adapted for inch sizes.

23. A tool with an adjustable gripper size, comprising
e) a catch (1),
(f) a fixed part (2),
g) a moving part (3),
h) whereby the fixed part (2) serves as a guide for the moving part (3) that is movable inside the fixed part (2) and
e) the catch selectively (1) fixes the moving part (3) to the fixed part (2).

24. A tool according to claim 23, wherein said fixed part and said movable part defining a gripping area between them at an end thereof.

25. A method of tool adjustment, comprising:
pushing a catch to allow two sets of teeth to slide past each other;
releasing said catch when said tool is correctly adjusted, so that said sets of teeth interlock.

26. A method according to claim 25, wherein said pressing is using a same hand that holds the tool.

27. A method according to claim 25, wherein said pushing both allows said teeth to slide and causes said sliding.

28. A method according to claim 25, comprising sliding said sets of teeth past each other in a single direction when said catch is not pushed.
